(19) United States
(12) Patent Application Publication
(10) Pub. No.: US 2017/0165830 A1
(43) Pub. Date: Jun. 15, 2017

(54) NOVEL TOOL MANAGEMENT SYSTEM TO STORE TOOLS

(71) Applicant: Douglas Vaughan, Tucson, AZ (US)

(72) Inventor: Douglas Vaughan, Tucson, AZ (US)

(21) Appl. No.: 14/967,115

(22) Filed: Dec. 11, 2015

(51) Int. Cl. B25H 3/04; F16B 1/00; A47B 81/00; F16M 13/02

(52) U.S. Cl. CPC B25H 3/04; F16M 13/027; F16B 1/00; A47B 81/005; F16B 2001/0035

(57) ABSTRACT

A tool management system to store tools comprising a magnetic grip made of an elastic material with a cylindrical body with a hollow interior section, which attaches to a handle of a tool by sliding over a top end of the handle of the tool. The magnetic grip also comprises a magnet. The system also comprises a hang flap comprising a metal strip to which the magnetic grip can attach. The tool management system further comprises a pair of brackets. A first end of the pair of brackets attaches to the hang flap by sliding inside a pair of pre-defined slots in the hang flap. The pre-defined slots comprise snap-fitting locks to firmly hold the first end. A second end of the pair of brackets is adapted to fit over a door or a shelf or a wall.

### FIELD OF THE INVENTION

The present invention relates generally to systems to store tools. The present invention is more particularly directed to a system comprising magnetic attachments to store tools.

### BACKGROUND OF THE INVENTION

Since time immemorial human beings have relied on a variety of tools to perform tasks which would either be very difficult or simply cannot be performed otherwise. Nowadays too, every household uses a plurality of tools on a daily basis. Usually, all of these tools have handles for easy handling, some have short handles and some have long handles. Tools with long handles have always been of great help to perform tasks which may require bending, stretching or aid of additional tools to reach the work surface. Such tasks may include but are not limited to, cleaning tasks which usually require cleaning tools such as mops, brooms, brushes, etc., all of which have long handles. This helps a user to clean floors, ceiling and various corners of the house without having to put undue stress on the user's body.

Though these long-handled tools are quite helpful, these are stored away in designated areas which are usually small and away from the day-to-day sight for both, aesthetics and hygiene reasons. However, the none handles often rinse a challenge in proper storage while trying to store these tools in the designated areas such as cupboards and closets, as the tools have poor stability, often resulting in clutter. Thus, in absence of proper storage, the quality of these tools and the associated work surfaces (e.g.—brush section of a broom) may get affected, which in turn would affect the quality of work these tools are intended for.

Several solutions have been proposed in prior art to solve the storage problem for the long-handled tools. However, none of these solutions are as effective as the solution proposed in the present application. Further, based on the description provided in the present application, it will be apparent to those skilled in the art that the solution of the present invention can be applied to short-handled tools as well.

### DESCRIPTION OF THE DRAWINGS

FIG. 1 is a top perspective view of a magnetic grip, as per an exemplary non-limiting embodiment of the present invention;

FIG. 2 is top view of the magnetic grip, as per the exemplary non-limiting embodiment of the present invention;

FIG. 3 is an exploded view of the magnetic grip, as per the exemplary non-limiting embodiment of the present invention;

FIG. 4 is a bottom view of the magnetic grip, as per the exemplary non-limiting embodiment of the present invention;

FIG. 5 is a cross-sectional view of the magnetic grip, as per the exemplary non-limiting embodiment of the present invention;

FIG. 6 is a top perspective view of a hang flap, as per an exemplary non-limiting embodiment of the present invention;

FIG. 7 is a bottom perspective view of the hang flap, as per the exemplary non-limiting embodiment of the present invention;

FIG. 8 is a side view of a tool management system, as per an exemplary non-limiting embodiment of the present invention;

FIG. 9 is an exploded bottom perspective view of a hang flap with raised ribs before thermoplastic staking, as per an exemplary non-limiting embodiment of the present invention;

FIG. 10 is a bottom perspective view of the hang flap with raised ribs before thermoplastic staking, as per the exemplary non-limiting embodiment of the present invention;

FIG. 11 shows a top perspective view of a hang flap and a pair of brackets, as per a first exemplary non-limiting embodiment of the present invention;

FIG. 12 shows a bottom perspective view of the hang flap and the pair of brackets, as per the first exemplary non-limiting embodiment of the present invention;

FIG. 13 shows another top perspective view of the hang flap, as per the first exemplary non-limiting embodiment of the present invention;

FIG. 14 shows a top perspective view of the hang flap and the pair of brackets mounted over a door, as per the first exemplary non-limiting embodiment of the present invention;

FIG. 15 shows a top perspective view of a hang flap and a pair of brackets, as per a second exemplary non-limiting embodiment of the present invention; and

FIG. 16 shows a top perspective view of a hang flap and a pair of brackets, as per a third exemplary non-limiting embodiment of the present invention.

### DETAILED DESCRIPTION OF THE INVENTION

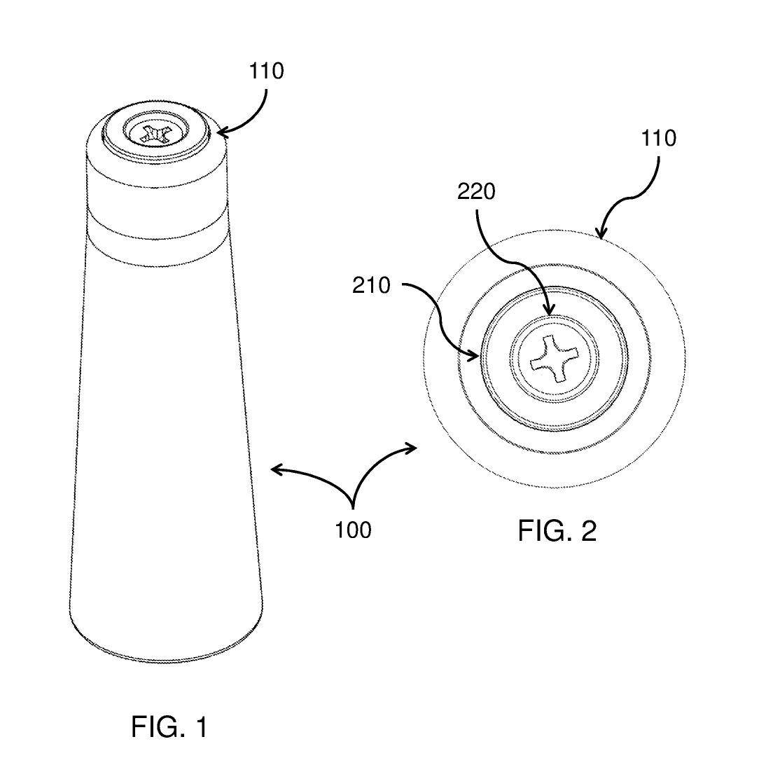

Construction and working of a tool management system to store tools as per the present invention has been explained henceforth using exemplary non-limiting embodiments of the present invention with reference to FIGS. 1, 2, 3, 4, 5, 6, 7, 8, 9, 10, 11, 12, 13, 14, 15 and 16. For the purpose of explaining, a non-limiting example of long-handled cleaning tools, such as a mop, has been used. However, it would be apparent to those skilled in the art that the present invention is equally applicable to any tool with a handle.

As per an exemplary non-limiting embodiment of the present invention, a tool management system comprises a magnetic grip 100, as shown in FIG. 1. A top surface 110 of the magnetic grip 100 comprises a magnet 210, as shown in FIG. 2. As per a preferred embodiment of the present invention, the magnet 210 is held in place by a screw 220 which passes through the magnet 210, as shown in FIG. 2, and fits through a pre-defined hole on the top surface 110 of the magnetic grip 100. The screw 220 fits into a bolt 310 which resides inside a hollow interior section of the magnetic grip 100, as shown in FIG. 3. As per other embodiments of the present invention, a variety of methods available in the existing art can be used to attach and secure the magnet 210 at the top surface 110 of the magnetic grip 100.

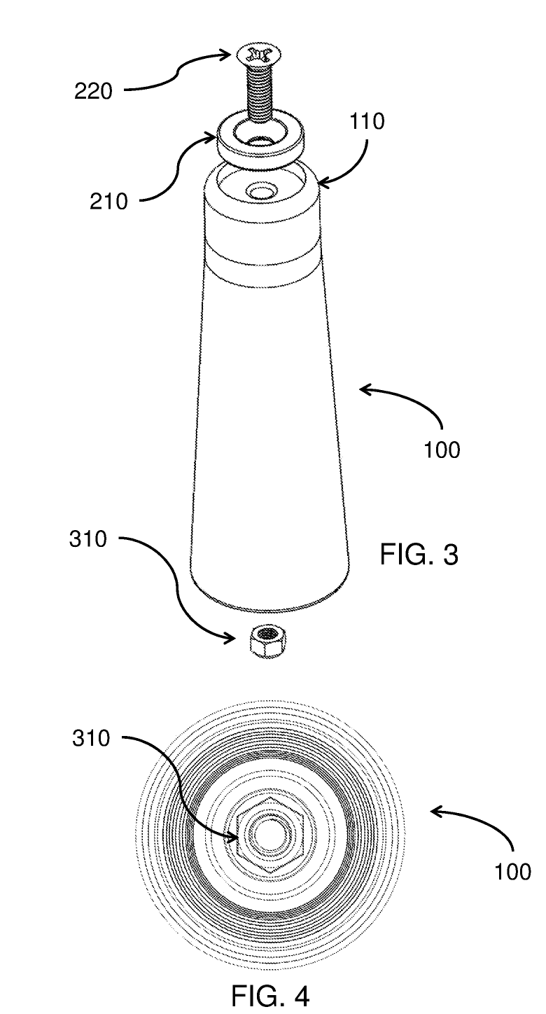

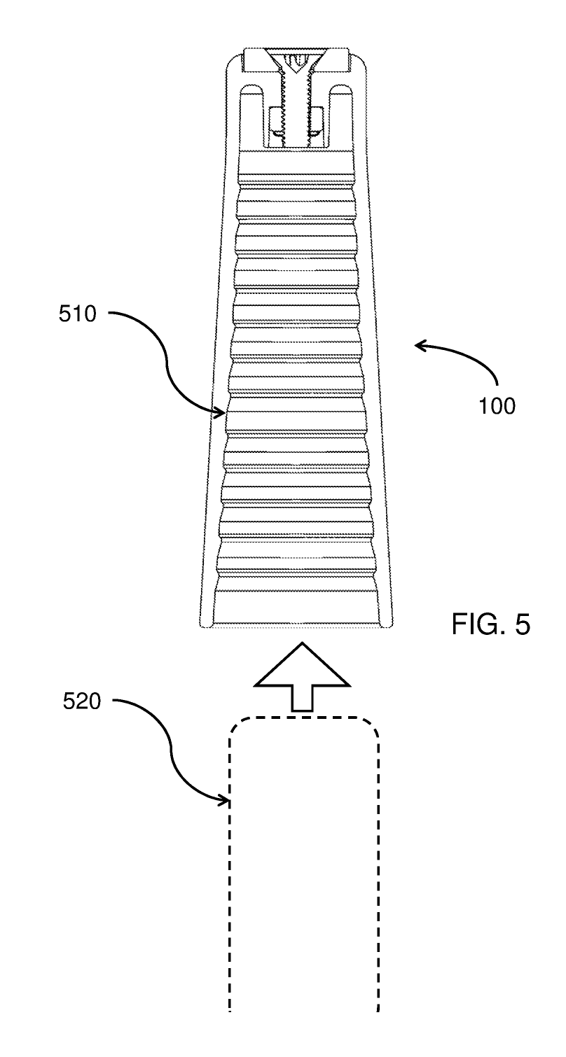

The magnetic grip 100 further comprises a cylindrical body with a hollow interior section, as shown in FIG. 4. The hollow interior section can be accessed through the open end of the magnetic grip 100, as shown in FIG. 5. The hollow interior section facilitates housing a top section of a free end of a handle of a mop 520 such that the top section fits inside the hollow interior section, as shown in FIG. 5. The hollow interior section may also have ribs 510, as shown in FIG. 5, to allow a tighter fit using frictional force generated when the top end of the handle of the mop 520 is inserted inside the hollow interior section of the magnetic grip 100. Thus, the mop gets securely attached to the magnetic grip 100 and can now be used with other components of the tool management system, as explained further. As per another embodiment of the present invention, the hollow interior section of the cylindrical body of the magnetic grip 100 may not have the ribs 510, and can be completely smooth.

The magnetic grip 100 should be made of a material that will make it easy to slide on the free end of the handle of the mop 520. However, the material of the magnetic grip 100 should also make it difficult to slide off the magnetic grip 100 from the free end of the handle of the mop 520. Further, the material should allow the magnetic grip 100 to be elastic so that a single magnetic grip 100 can be used for handles with varying size. At the same time, the material should be durable enough to handle any wear and tear from daily use.

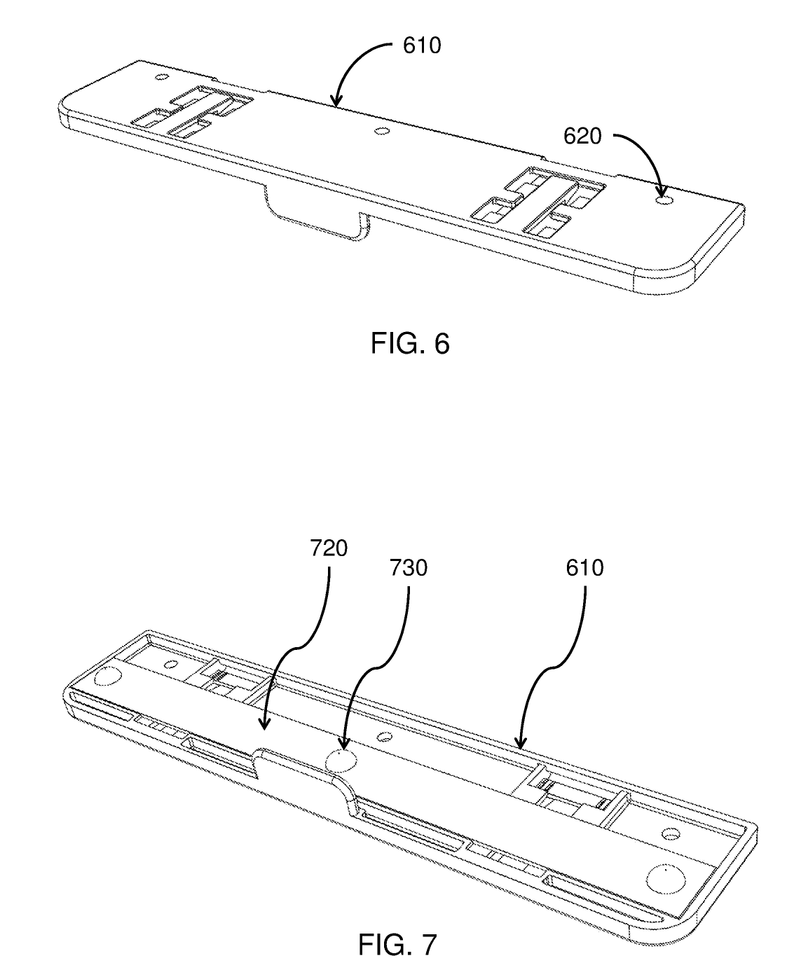

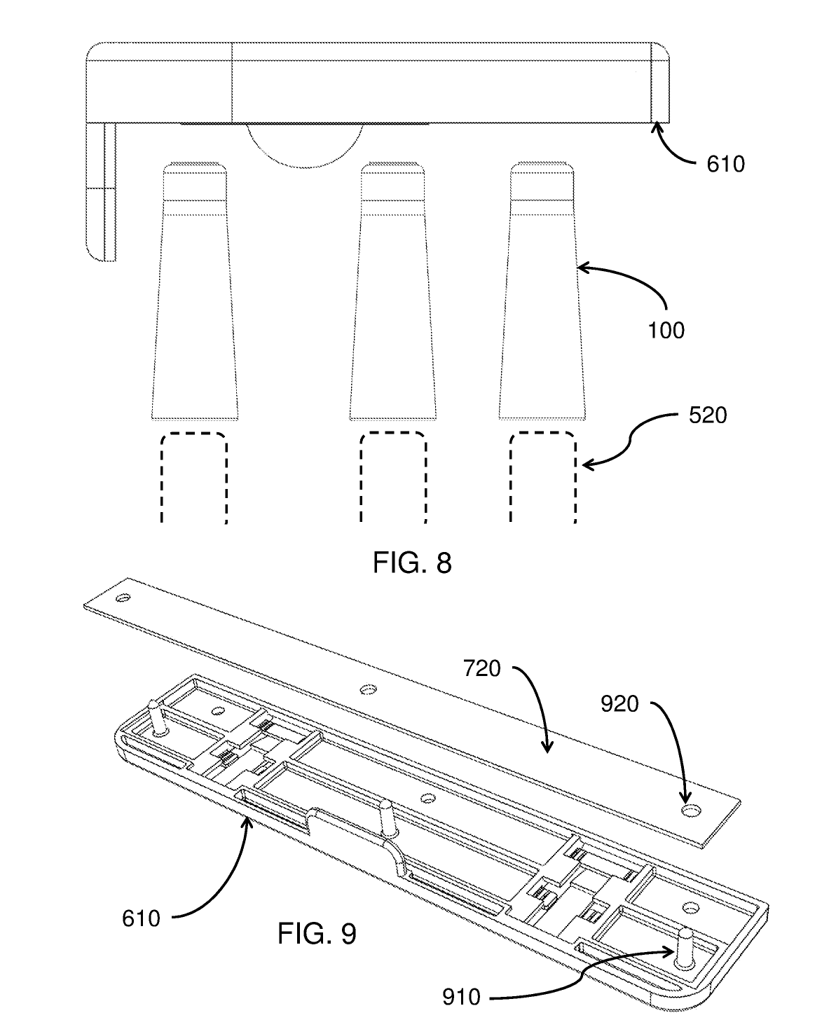

The tool management system further comprises a hang flap 610, as shown in FIG. 6 and FIG. 7. As per a preferred embodiment of the present invention, the hang flap 610 comprises a body of strong plastic material, and a metal strip 720 which provides a base for the magnetic grip 100 and the attached mop to attach to. As shown in FIG. 8, a plurality of magnetic grips 100 and attached tools (mops as per this embodiment) can be attached to the hang flap 610, facilitated by the magnetic attraction force between the magnetic grip 100 and the metal strip 720.

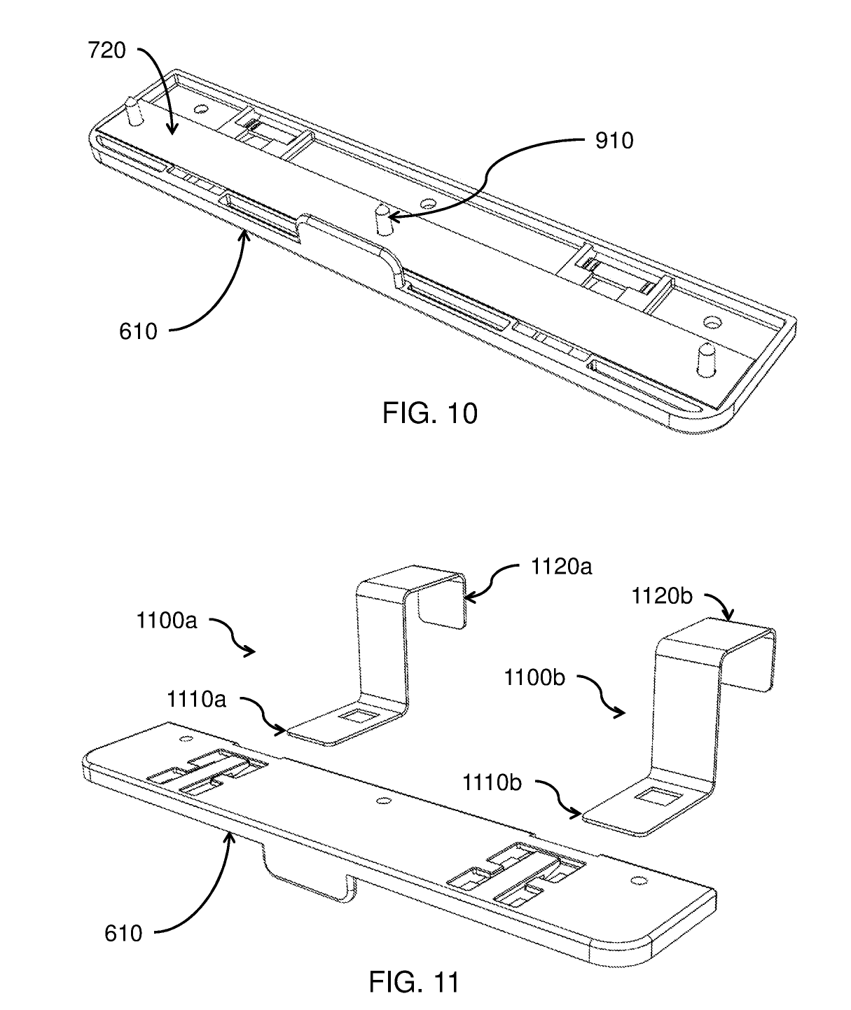

It will be apparent to those skilled in the art that a variety of methods known in the existing arts can be used to attach the metal strip 720 to the body of the hang flap 610. This may include, but is not limited to, using an adhesive, screws and thermoplastic staking. As per a preferred embodiment of the present invention, the metal strip 720 is attached to the body of the hang flap 610 using thermoplastic staking. For the purpose of thermoplastic staking, the body of the hang flap 610 comprises a plurality of raised posts 910, as shown in FIG. 9. The raised posts 910 pass through the pre-defined slots 920 on the metal strip 720, as shown in FIG. 10, and upon application of thermoplastic staking a plurality of rivets 730 are formed, shown in FIG. 7, which ensure the metal strip 720 is strongly attached to the plastic body of the hang flap 610.

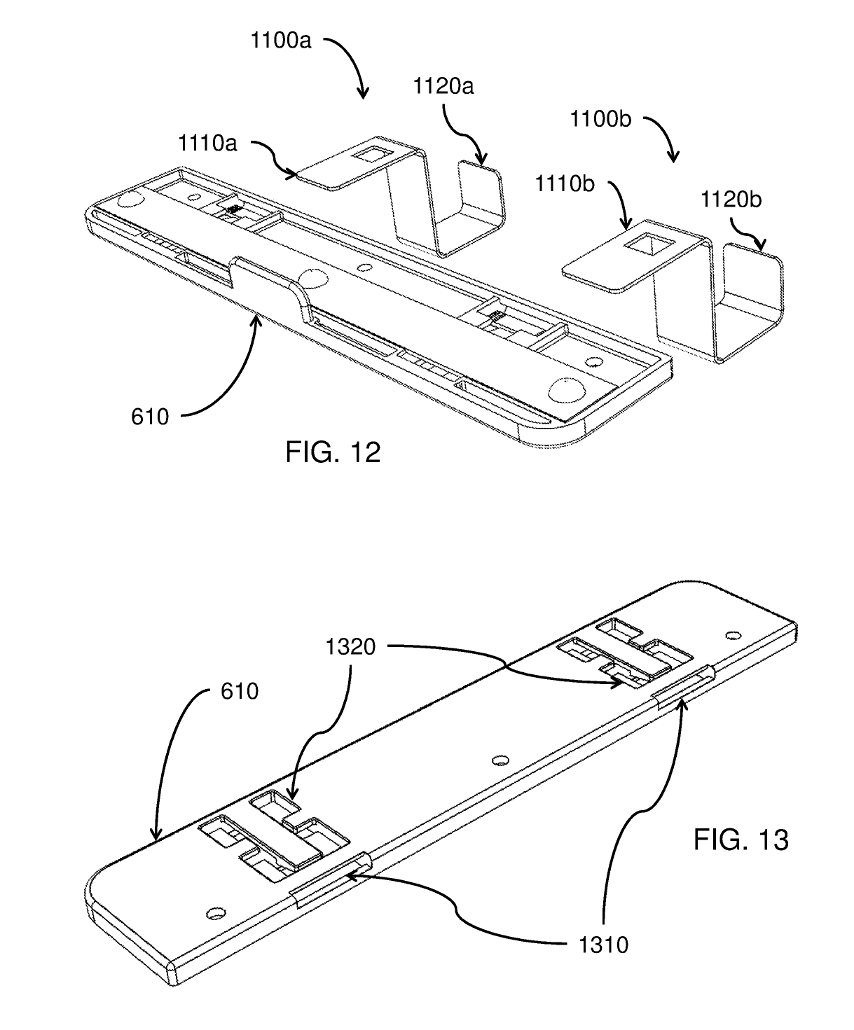

The tool management system further comprises a pair of brackets (1100a, 1100b), as shown in FIG. 11 and FIG. 12, as per a first exemplary non-limiting embodiment of the present invention. A first end (1110a, 1110b) of each of the brackets (1100a, 1100b) slides inside one of the two pre-defined slots 1310 in the body of the hang flap 610, as shown in FIG. 13. It will be apparent to those skilled in the arts that a variety of methods known in the existing arts can be used to attach the first end (1110a, 1110b) of each of the brackets (1100a, 1100b) to the body of the hang flap 610. In some embodiments, the tool management system might comprise only one bracket and a corresponding pre-defined slot in the body of the hang flap 610.

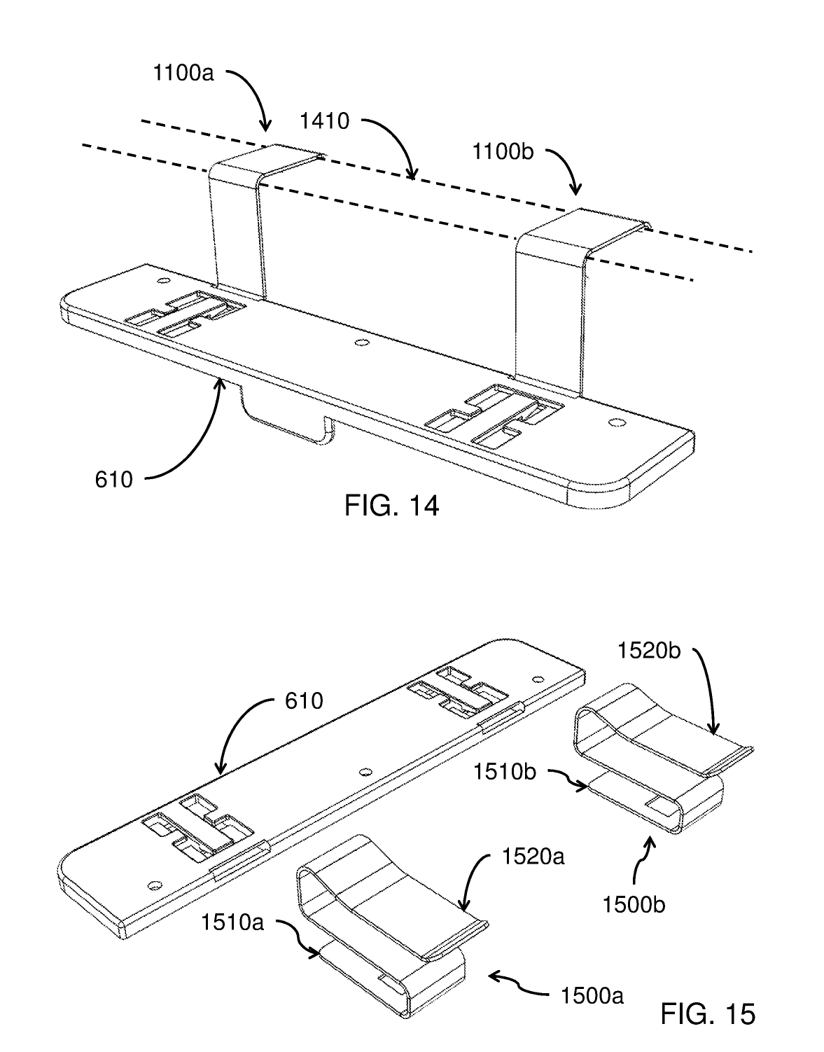

The pre-defined slots comprise snap-fitting locks 1320 to hold the first ends (1110a, 1110b) of each of the brackets (1100a, 1100b) firmly in place, as shown in FIG. 13. It will be apparent to those skilled in the art that a variety of methods known in the existing arts can be used to hold the first ends (1110a, 1110b) of each of the brackets (1100a, 1100b) firmly in place. A second end (1120a, 1120b) of each of the pair of brackets (1100a, 1100b), as shown in FIG. 11 and FIG. 12, is adapted to fit over a door 1410, as shown in FIG. 14. This fit over the door 1410 allows the hang flap 610 and the pair of brackets (1100a, 1100b) to get attached to the door 1410 as shown in FIG. 14. Now, a user can easily hang and store the mop 520, with the magnetic cap 100 attached to the top section of the handle of the mop 520, by attaching the magnetic cap 100 to the metal strip 720 on the hang flap 610.

As per a second exemplary non-limiting embodiment of the present invention, a second end (1520a, 1520b) of a pair of brackets (1500a, 1500b) is adapted to fit over a shelf, as shown in FIG. 15. As shown in FIG. 15, the design of the second end (1520a, 1520b) allows for a tight grip of the top and bottom surfaces of the shelf using frictional force, which in turn allows the attached hang flap 610 to remain securely attached to the shelf. Now, a user can easily hang and store the mop 520, with the magnetic cap 100 attached to the top section of the handle of the mop 520, by attaching the magnetic cap 100 to the metal strip 720 on the hang flap 610.

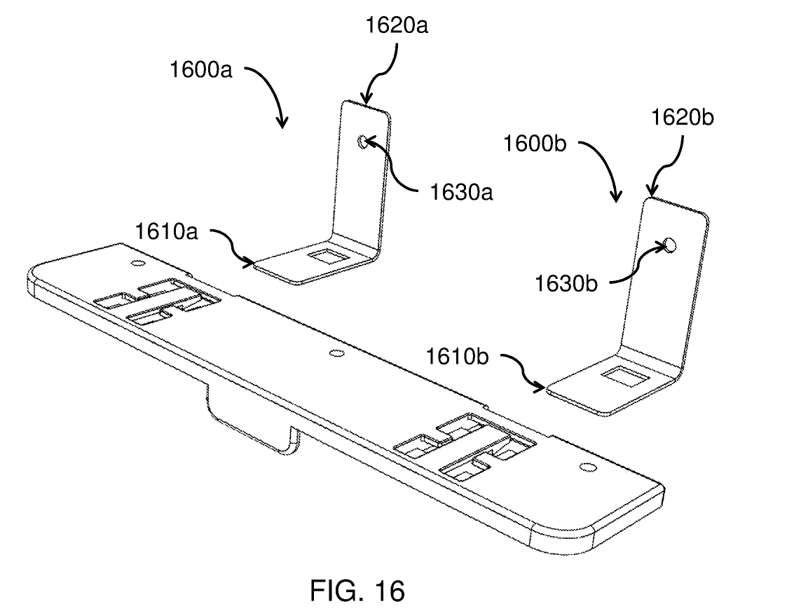

As per a third exemplary non-limiting embodiment of the present invention, a second end (1620a, 1620b) of a pair of brackets (1600a, 1600b) is adapted in such a manner so that the pair of brackets (1600a, 1600b) and the attached hang flap 610 can be affixed to a wall, as shown in FIG. 16. As per a preferred embodiment of the present invention, the second end (1620a, 1620b) can be affixed to the wall using screws which will pass through screw holes (1630a, 1630b) on each of the pair of brackets (1600a, 1600b), as shown in FIG. 16. It will be apparent to those skilled in the art that a variety of methods known in the existing arts can be used to affix the second end (1620a, 1620b) to the wall. Now, a user can easily hang and store the mop 520, with the magnetic cap 100 attached to the top section of the handle of the mop 520, by attaching the magnetic cap 100 to the metal strip 720 on the hang flap 610.

In yet another embodiment of the present invention, the hang flap 610 can be directly attached to a ceiling by the user. As per a preferred embodiment of the present invention, the hang flap 610 can be affixed to the ceiling using screws which will pass through screw holes 620, as shown in FIG. 6. It will be apparent to those skilled in the art that a variety of methods known in the existing arts can be used to affix the hang flap 610 to the ceiling. Now, a user can easily hang and store the mop 520, with the magnetic cap 100 attached to the top section of the handle of the mop 520, by attaching the magnetic cap 100 to the metal strip 720 on the hang flap 610.

As can be clearly understood from the description above, the tool management system of the present invention solves the problem of conveniently and efficiently storing tools with handles, especially those with long handles, by providing a system which can easily adapt to any available surface and provide a clutter-free way of storing the tools in a small space.

Various modifications to the above described invention will be readily apparent to those skilled in the art and the general principles defined herein may be applied to other embodiments and applications without departing from the spirit and scope of the present invention. Thus, the present invention is not intended to be limited to the embodiments described, but is to be accorded the widest scope consistent with the principles and features disclosed herein.

Therefore, the scope of the invention is to be determined by the terminology of the above description and the legal equivalents thereof.

What is claimed is:

1. A tool management system to store tools comprising:
a magnetic grip, wherein the magnetic grip attaches to a handle of a tool, and wherein the magnetic grip comprises a magnet to allow the magnetic grip to attach to a metal surface; and
a hang flap, wherein the hang flap comprises a metal strip to which the magnetic grip, and the handle of the tool attached to the magnetic grip, can attach to store the tool at a location where the hang flap is installed.

2. The tool management system of claim 1, further comprising a pair of brackets, wherein a first end of each of the pair of brackets attaches to the hang flap.

3. The tool management system of claim 1, wherein the magnetic grip attaches to the handle of the tool by sliding over a top end of the handle of the tool, and covering the top end from all sides.

4. The tool management system of claim 3, wherein the magnetic grip is made of an elastic material.

5. The tool management system of claim 3, wherein the magnetic grip comprises a cylindrical body with a hollow interior section, wherein the top end of the handle of the tool fits inside the hollow interior section.

6. The tool management system of claim 5, wherein the hollow interior section comprises ribs to allow a tighter fit of the top end of the handle inside the hollow interior section.

7. The tool management system of claim 2, wherein the hang flap comprises a pair of pre-defined slots such that a first end of each of the pair of brackets can slide inside the pre-defined slots.

8. The tool management system of claim 7, wherein the pre-defined slots comprise snap-fitting locks to firmly hold the first end of each of the pair of brackets.

9. The tool management system of claim 7, wherein a second end of each of the pair of brackets is adapted to fit over a door.

10. The tool management system of claim 7, wherein a second end of each of the pair of brackets is adapted to fit over a shelf.

11. The tool management system of claim 7, wherein a second end of each of the pair of brackets is adapted to be attached to a wall.

12. The tool management system of claim 1, wherein the hang flap can be directly installed on a ceiling by attaching the hang flap to the ceiling using screws.

13. A tool management system to store tools comprising:
a magnetic grip made of an elastic material, wherein the magnetic grip attaches to a handle of a tool by sliding over a top end of the handle of the tool, and covering the top end from all sides, and wherein the magnetic grip comprises a magnet to allow the magnetic grip to attach to a metal surface;
a hang flap, wherein the hang flap comprises a metal strip to which the magnetic grip, and the handle of the tool attached to the magnetic grip, can attach to store the tool at a location where the hang flap is installed; and
a pair of brackets, wherein a first end of each of the pair of brackets attaches to the hang flap, wherein the hang flap comprises a pair of pre-defined slots such that the first end of each of the pair of brackets can slide inside the pre-defined slots, and wherein the pre-defined slots comprise snap-fitting locks to firmly hold the first end of each of the pair of brackets.

14. The tool management system of claim 13, wherein the magnetic grip comprises a cylindrical body with a hollow interior section, wherein the top end of the handle of the tool fits inside the hollow interior section, and wherein the hollow interior section comprises ribs to allow a tighter fit of the top end of the handle inside the hollow interior section.

15. The tool management system of claim 13, wherein a second end of each of the pair of brackets is adapted to fit over a door.

16. The tool management system of claim 13, wherein a second end of each of the pair of brackets is adapted to fit over a shelf.

17. The tool management system of claim 13, wherein a second end of each of the pair of brackets is adapted to be attached to a wall.

18. The tool management system of claim 13, wherein the hang flap can be directly installed on a ceiling by attaching the hang flap to the ceiling using screws, without the need of the pair of brackets.

19. A tool management system to store tools comprising:
a magnetic grip made of an elastic material, wherein the magnetic grip comprises a cylindrical body with a hollow interior section, and wherein the magnetic grip attaches to a handle of a tool by sliding over a top end of the handle of the tool and covering the top end from all sides in such a manner that the top end of the handle of the tool fits inside the hollow interior section, and wherein the hollow interior section comprises ribs to allow a tighter fit of the top end of the handle inside the hollow interior section, and wherein the magnetic grip comprises a magnet to allow the magnetic grip to attach to a metal surface;
a hang flap, wherein the hang flap comprises a metal strip to which the magnetic grip, and the handle of the tool attached to the magnetic grip, can attach to store the tool at a location where the hang flap is installed; and
a pair of brackets, wherein a first end of each of the pair of brackets attaches to the hang flap, wherein the hang flap comprises a pair of pre-defined slots such that the first end of each of the pair of brackets can slide inside the pre-defined slots, and wherein the pre-defined slots comprise snap-fitting locks to firmly hold the first end of each of the pair of brackets, and wherein a second end of each of the pair of brackets is adapted to fit over a door or a shelf or a wall.

20. The tool management system of claim 19, wherein the hang flap can be directly installed on a ceiling by attaching the hang flap to the ceiling using screws, without the need of the pair of brackets.
